(19) United States
(12) Patent Application Publication
(10) Pub. No.: US 2021/0073428 A1
(43) Pub. Date: Mar. 11, 2021

(54) STRUCTURE TOPOLOGY OPTIMIZATION METHOD BASED ON MATERIAL-FIELD REDUCED SERIES EXPANSION

(71) Applicant: DALIAN UNIVERSITY OF TECHNOLOGY, Dalian, Liaoning (CN)

(72) Inventors: Yangjun LUO, Dalian, Liaoning (CN); Zhan KANG, Dalian, Liaoning (CN); Pai LIU, Dalian, Liaoning (CN)

(21) Appl. No.: 16/757,669

(22) PCT Filed: Aug. 12, 2019
(86) PCT No.: PCT/CN2019/100131

§ 371 Date: Apr. 20, 2020

(30) Foreign Application Priority Data
Apr. 26, 2019 (CN) 201910341472.6

(51) Int. Cl. G06F 30/10; G06F 30/23

(52) U.S. Cl. CPC G06F 30/10; G06F 2111/10; G06F 30/23

(57) ABSTRACT

A structure topology optimization method based on material-field reduced series expansion is disclosed. A bounded material field that takes correlation into consideration is defined, the bounded material field is transmitted into a linear combination of a series of undetermined coefficients using a spectral decomposition method, these undetermined coefficients are used as design variables, an optimization model is built based on an element density interpolation model, the topology optimization problem is solved using a gradient-based or gradient-free algorithm, and then a topology configuration with clear boundaries is obtained efficiently. The method can substantially reduce the number of design variables in density method-based topology optimization, and has the natural advantage of completely avoiding the problems of mesh dependency and checkerboard patterns.

### TECHNICAL FIELD

The present invention belongs to the field of lightweight design of mechanical, aeronautical and astronautical engineering equipment structures, and relates to a structure topology optimization method based on material-field series expansion.

### BACKGROUND

At present, the main methods for topology optimization of continuum structures include a density-based method, a level set method and a (bidirectional) evolutionary structural optimization method. Among them, the density-based method is widely used in the innovative topology optimization design of mechanical, aeronautical and astronautical engineering structures because of simple model and convenient implementation, and is integrated in many optimization design business software. In the density-based method, the topology optimization problem of discrete variables of 0-1 is converted into an optimization problem of continuous design variables by introducing the relative density of intermediate material between 0 and 1 and the penalizing technique, and the optimization problem is efficiently solved through gradient-based optimization algorithms. However, in the density-based method, the number of design variables depends on the number of finite elements. Secondly, the density-based method itself cannot solve the inherent mesh dependency and the checkerboard patterns in the topology optimization design, there is a need to control the above problems by applying a minimum length-scale through a density filtering method, a sensitivity filtering method, or other filtering methods, thereby causing additional computational cost. Therefore, when dealing with large-scale topology optimization problems with fine meshes, filtering a large number of sensitivities or relative densities and updating relative densities become the most time-consuming steps besides finite element analysis in solving the topology optimization problem. In addition, the traditional density method can only use the gradient-based algorithm to solve problems due to too many design variables, and cannot be applied to complex problems where it is difficult to obtain sensitivities directly. In order to effectively reduce the computational cost caused by iteratively updating large-scale design variables, a feasible option is to propose a new topology optimization method based on material-field reduced series expansion under the density-based method framework, which substantially reduces the number of design variables, improves the optimization solving efficiency, is suitable for solving through gradient-free algorithms, and effectively eliminates mesh dependency and checkerboard patterns.

### SUMMARY

With respect to the disadvantage of too many design variables in the traditional density method when dealing with large-scale complex structure topology optimization problems, the present invention provides a topology optimization design method for substantially reducing the dimensionality of design variable space in density-based topology optimization problems, have the natural advantages of completely avoiding the problems of mesh dependency and checkerboard patterns. The present invention is suitable for innovative topology optimization design of mechanical, aeronautical and astronautical engineering equipment, is suitable for solving through gradient-free algorithms, is beneficial to improving optimization efficiency, and is particularly suitable for solving large-scale three-dimensional structure topology design problems.

To achieve the above purpose, the present invention adopts the following technical solution:

A structure topology optimization method based on material-field reduced series expansion, mainly comprising two parts, i.e. material-field reduced series expansion, and structure topology optimization modeling, specifically including the steps as follows:

Step 1: Discretization and Reduced Series Expansion of Material Field of Design Domain

1.1) Determining a two-dimensional or three-dimensional design domain according to actual conditions and size requirements of a structure, defining a bounded material-field function with spatial dependency, and uniformly selecting several observation points in the design domain to discretize the material field; controlling the number of the observation points within 10,000; limiting the material-field function to [−1, 1], defining the correlation between any two points in the material field by a correlation function that depends on the spatial distance between the two points, that is, C(x₁, x₂)=exp(−∥x₁−x₂∥²/l_{c}²), where x₁ and x₂ represent spatial positions of the two points, l_{c} represents a correlation length, and ∥ ∥ represents 2-norm.

1.2) Determining the correlation length, calculating the correlation among all the observation points, and constructing a symmetric positive-definite correlation matrix with a diagonal of 1, wherein the correlation length is not greater than 25% of the length of the long side of the design domain.

1.3) Conducting eigenvalue decomposition on the symmetric positive-definite correlation matrix in step 1.2), sorting eigenvalues from big to small, selecting the first several eigenvalues according to the truncation criterion, wherein the truncation criterion is: the sum of the selected eigenvalues accounts for 99.9999 of the sum of all eigenvalues.

1.4) Conducting reduced series expansion on the material field, that is, φ(x)=η^{T}Λ^{-1/2}ψ^{T}C(x), where η represents the vector of undetermined series expansion coefficients, A represents a diagonal matrix composed of the eigenvalues selected in 1.3), ψ represents a matrix composed of corresponding eigenvectors in 1.3), and C(x) represents a correlation vector between x and all observation points obtained through the correlation function in step 1.1).

Step 2. Topology Optimization of Structure

2.1) Firstly, conducting finite element meshing on the design domain, establishing a power-law interpolation relationship between the elastic modulus of a finite element and the material field; secondly, applying loads and boundary conditions in the design domain, to conduct finite element analysis; and finally, building a structure topology optimization model, wherein the optimization objective is to maximize the structural stiffness or minimize the structural compliance, and constraint conditions and design variables are as follows:

a) constraint condition 1: it is required that the material-field function value of each observation point is not greater than 1;

b) constraint condition 2: the structural material consumption is determined as not greater than the material volume constraint upper limit; the upper limit of material volume is 5%-50% of the volume of the design domain;

c) design variables: the vector of design variables is the reduced series expansion coefficient vector η of the material field, the value of each design variable being between −100 and 100.

2.2) According to the structure topology optimization model built in step 2.1), conducting sensitivity analysis on optimization objective and constraint conditions; conducting iterative solution using a gradient-based algorithm or gradient-free algorithm, using an active-constraint strategy in the iterative process, only counting constraint conditions where the material-field function value of the current observation point is greater than −0.3 in the algorithm, thus obtaining structural optimal material distribution.

Further, the correlation function in step 1.1) comprises an exponential-model function and a Gaussian model function.

Further, the expression of the power-law interpolation relationship of the elastic modulus of the element in step 2.1) is

$$E ( x ) = ( \frac{1 + \text{?} \text{?}}{2} ) \text{?} {E}_{0} , \\ \text{?} \text{indicates text missing or illegible when filed}$$

where [symbol]
and φ(x) represent Heaviside projection functions, the smoothing parameter increases stepwise from 0 to 9, that is, increases by 1.5 each time after the convergence condition is met; the convergence condition is that the relative change of the objective function between two successive iterations is less than 0.005; p represents a penalization factor, which is 3 in general; and E₀ represents an elastic modulus of the material.

Further, the gradient-based algorithm in step 2.2) is the optimality criteria method or method of moving asymptotes, and the gradient-free algorithm is the surrogate model-based method or genetic algorithm.

The present invention has the beneficial effects that when the traditional density-based topology optimization is used in topology design of large-scale complex structures, the optimization efficiency is seriously affected due to many design variables and need of a time-consuming sensitivity filtering or density filtering method. By adopting the method of the present invention to conduct topology optimization design of large-scale complex structures, the dimensionality of design variable space can be substantially reduced, and a topology configuration with clear boundaries can be obtained efficiently. The method inherits the advantages of simple form, convenient engineering promotion, easy understanding and programming, etc. of the density method, has a fast optimization solving speed, is suitable for solving through gradient-free algorithms, and may ensure the research and development efficiency of the innovative topology design of complex equipment structures.

### DESCRIPTION OF DRAWINGS

FIG. 1 shows a design domain of a two-dimensional MBB beam structure provided in embodiments of the present invention. In the figure: F represents a load applied to the structure.

FIG. 2 shows an optimal topology configuration of a two-dimensional MBB beam structure.

FIG. 3 shows a design domain of a three-dimensional cantilever beam structure provided in embodiments of the present invention.

FIG. 4(a) is diagram showing optimal topology design of a three-dimensional cantilever beam structure when the material volume ratio is 7.5%.

FIG. 4(b) is diagram showing optimal topology design of a three-dimensional cantilever beam structure when the material volume ratio is 30%.

### DETAILED DESCRIPTION

Specific embodiments of the present invention are described below in detail in combination with the technical solution and accompanying drawings.

A structure topology optimization method based on material-field reduced series expansion. In the topology optimization method, a bounded material field that takes spatial correlation into consideration is defined, the bounded material field is transmitted into a linear combination of a series of undetermined coefficients using a spectral decomposition method, these undetermined coefficients are used as design variables, the topology optimization problem is built using an element density interpolation model and solved by a gradient-based algorithm, and then a topology configuration with clear boundaries is obtained efficiently.

Step 1: Discretization and Reduced Series Expansion of Material Field of Design Domain

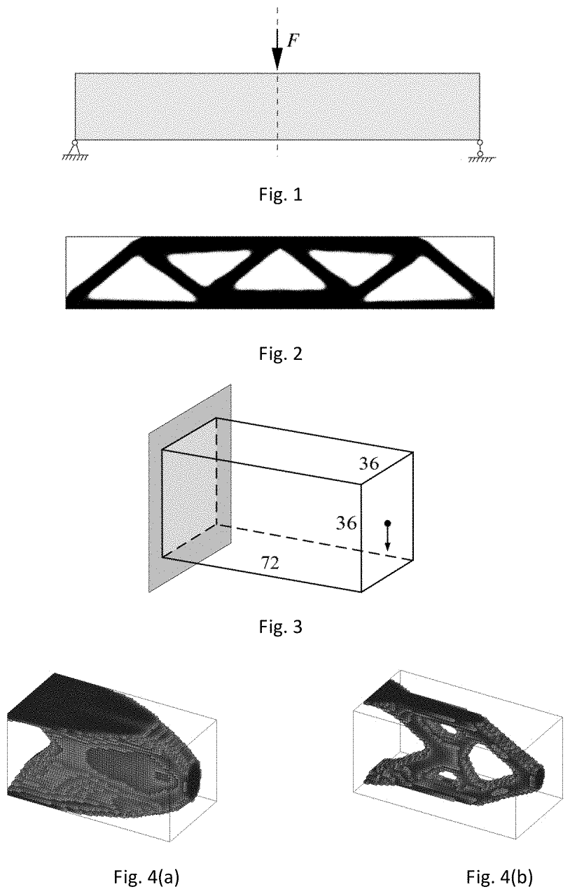

1.1) Determining a two-dimensional or three-dimensional design domain according to actual conditions and size requirements of a structure, uniformly selecting several observation points in the design domain, and defining a bounded material-field function with spatial dependency, wherein FIG. 1 shows a design domain of a two-dimensional MBB beam structure, the design domain is 180 mm in length and 30 mm in width, and the number N of the uniformly distributed observation points selected is equal to 2700; FIG. 3 shows a design domain of a three-dimensional cantilever beam structure, and the number N of the uniformly distributed observation points selected is equal to 6570; limiting the material-field function to [−1, 1], defining the correlation between any two points in the material field by a correlation function that depends on the spatial distance between the two points, the expression being C(x₁,x₂)=exp(−∥x₁−x₂∥²/l_{c}²).

1.2) Determining the correlation length, calculating the correlation among all the observation points, and constructing a symmetric positive-definite correlation matrix with a diagonal of 1, wherein the correlation length l_{c} of the material field in FIG. 1 is equal to 2 mm and 8 mm, and the correlation length l_{c} of the material field in FIG. 3 is equal to 6 mm.

1.3) Conducting eigenvalue decomposition on the eigenvalue matrix, sorting eigenvalues from big to small, selecting the first several eigenvalues according to the truncation criterion, wherein the truncation criterion is: the sum of the selected eigenvalues accounts for 99.9999 of the sum of all eigenvalues.

1.4) Conducting reduced series expansion on the material field, that is, φ(x)=η^{T}Λ^{1/2}ψ^{T}t(x), where η represents the vector of undetermined series expansion coefficients, A represents a diagonal matrix composed of the eigenvalues selected in 1.3), ψ represents a vector composed of corresponding eigenvectors, and C(x) represents a correlation vector obtained through the correlation function in 1.1).

Step 2. Topology Optimization of Structure

2.1) Firstly, conducting finite element meshing on the design domain, wherein the number NE of the finite element meshes partitioned in the design domain in FIG. 1 is equal to 43200, and the number NE of the finite element meshes partitioned in the design domain in FIG. 3 is equal to 93312; establishing a power-law interpolation relationship between the elastic modulus of finite elements and the material field, i.e.

$$E ( x ) = ( \frac{1 + \text{?} \text{?}}{2} ) \text{?} {E}_{0} , \\ \text{?} \text{indicates text missing or illegible when filed}$$

where [symbol]
and φ(x) represent Heaviside projection functions, the smoothing parameter increases stepwise from 0 to 9, that is, increases by 1.5 each time after the convergence condition is met; the convergence condition is that the relative change of the objective function between two successive iterations is less than 0.005; secondly, in the design domain, applying loads and constraint boundaries in the design domain, and conducting finite element analysis; and finally, building a structure topology optimization model to minimize the structural compliance.

a) constraint condition 1: it is required that the material-field function value of each observation point is not greater than 1;

b) constraint condition 2: the structural material consumption is determined as not greater than the material volume constraint upper limit; the upper limit of material volume ratio in FIG. 1 is 50%, and the upper limit of material volume ratio in FIG. 3 is 7.5% and 30%;

c) design variables: the vector of design variables is the reduced series expansion coefficient vector η of the material field, the value of each design variable being between −100 and 100.

2.2) According to the topology optimization model built in step 2.1), conducting sensitivity analysis on objective functions and constraint conditions; conducting iterative solution using a gradient-based algorithm or gradient-free algorithm, using an active-constraint strategy in the iterative process, only counting constraint conditions where the material-field function value of the current observation point is greater than −0.3 in the optimization algorithm, thus obtaining a structural optimal topology configuration, as shown in FIG. 2 and FIG. 4 respectively.

The essence of the present invention is to introduce a material field with spatial dependency, and transform a continuous material field using a spectral decomposition method, to achieve the purpose of reducing the number of design variables, and avoid the checkerboard patterns and mesh dependency inherently. Any methods that simply modify the optimization model and solving algorithm contained in the above-mentioned embodiments, or makes equivalent replacement on some or all method features (for example, using other power-law interpolation relationships, changing an objective function or constraining specific form), do not deviated from the scope of the present invention.

1. A structural topology optimization method based on material-field reduced series expansion, mainly comprising two parts, i.e. material-field reduced series expansion, and structural topology optimization modeling, including the steps as follows:
step 1: discretization and reduced series expansion of material field of design domain
1.1) determining a two-dimensional or three-dimensional design domain according to actual conditions and size requirements of a structure, defining a bounded material-field function with spatial dependency, and uniformly selecting several observation points in the design domain to discretize the material field; controlling the number of the observation points within 10,000; limiting the material-field function to [−1, 1], defining the correlation between any two points in the material field by a correlation function that depends on the spatial distance between the two points, that is, C(x₁,x₂)=exp(−∥x₁−x₂∥²/l_{c}²), where x₁ and x₂ represent spatial positions of the two points, l_{c} represents a correlation length, and ∥ ∥ represents 2-norm;
1.2) determining the correlation length, calculating the correlation among all the observation points, and constructing a symmetric positive-definite correlation matrix with a diagonal of 1, wherein the correlation length is not greater than 25% of the length of the long side of the design domain;
1.3) conducting eigenvalue decomposition on the symmetric positive-definite correlation matrix in step 1.2), sorting eigenvalues from big to small, selecting the first several eigenvalues according to the truncation criterion, wherein the truncation criterion is: the sum of the selected eigenvalues accounts for 99.9999% of the sum of all eigenvalues; and
1.4) conducting reduced series expansion on the material field, that is, φ(x)=η^{T}Λ^{-1/2}ψ^{T}C(x), where η represents the vector of undetermined series expansion coefficients, Λ represents a diagonal matrix composed of the eigenvalues selected in 1.3), ψ represents a matrix composed of corresponding eigenvectors in 1.3), and C(x) represents a correlation vector between x and all observation points obtained through the correlation function in step 1.1);
step 2. topology optimization of structure
2.1) firstly, conducting finite element meshing on the design domain, establishing a power-law interpolation relationship between the elastic modulus of finite elements and the material field; secondly, applying loads and boundary conditions in the design domain, to conduct finite element analysis; and finally, building a structural topology optimization model, wherein the optimization objective is to maximize the structural stiffness or minimize the structural compliance, and constraint conditions and design variables are as follows:
a) constraint condition 1: it is required that the material-field function value of each observation point is not greater than 1;
b) constraint condition 2: the structural material consumption is determined as not greater than the material volume constraint upper limit; the upper limit of material volume is 5%-50% of the volume of the design domain;
c) design variables: the vector of design variables is the reduced series expansion coefficient vector η of the material field, the value of each design variable being between −100 and 100;
2.2) according to the structural topology optimization model built in step 2.1), conducting sensitivity analysis on optimization objective and constraint conditions; conducting iterative solution using a gradient-based algorithm or gradient-free algorithm, using an active-constraint strategy in the iterative process, only counting constraint conditions where the material-field function value of the current observation point is greater than −0.3 in the algorithm, thus obtaining structural optimal material distribution.

2. The structural topology optimization method based on material-field reduced series expansion according to claim 1, wherein the correlation function in step 1.1) comprises an exponential-model function and a Gaussian model function.

3. The structural topology optimization method based on material-field reduced series expansion according to claim 1, wherein the expression of the power-law interpolation relationship of the elastic modulus of the element in step 2.1) is
$$E ( x ) = ( \frac{1 + \text{?} \text{?}}{2} ) \text{?} {E}_{0} , \\ \text{?} \text{indicates text missing or illegible when filed}$$
where [symbol]
and φ(x) represent Heaviside projection functions, the smoothing parameter increases stepwise from 0 to 9, that is, increases by 1.5 each time after the convergence condition is met; the convergence condition is that the relative change of the objective function between two successive iterations is less than 0.005; p represents a penalization factor; and E₀ represents an elastic modulus of the material.

4. The structural topology optimization method based on material-field reduced series expansion according to claim 1, wherein the gradient-based algorithm in step 2.2) is the optimality criteria method or method of moving asymptotes, and the gradient-free algorithm is the surrogate model-based method or genetic algorithm.

5. The structural topology optimization method based on material-field reduced series expansion according to claim 3, wherein the gradient-based algorithm in step 2.2) is the optimality criteria method or method of moving asymptotes, and the gradient-free algorithm is the surrogate model-based method or genetic algorithm.
